(19) United States
(12) Patent Application Publication
(10) Pub. No.: US 2024/0343000 A1
(43) Pub. Date: Oct. 17, 2024

(54) CUSTOM, USER-SPECIFIC FIREARM GRIP AND METHOD OF MANUFACTURE

(71) Applicants: Keith Bernkrant, Cocoa, FL (US); Simon Oliver, Lakeland, TN (US)

(72) Inventors: Keith Bernkrant, Cocoa, FL (US); Simon Oliver, Lakeland, TN (US)

(21) Appl. No.: 18/634,987

(22) Filed: Apr. 14, 2024

Related U.S. Application Data
(60) Provisional application No. 63/459,586, filed on Apr. 14, 2023.

(51) Int. Cl. B29C 69/02; A63B 60/12; B25G 1/10; B29C 37/00; B29C 64/10; B29C 64/386; B29K 77/00; B29L 31/00; B33Y 10/00; B33Y 50/00; B33Y 70/00; B33Y 80/00; F41C 23/16

(52) U.S. Cl. CPC B29C 69/02; B29C 37/0053; B29C 64/10; B29C 64/386; B33Y 10/00; B33Y 50/00; B33Y 80/00; F41C 23/16; A63B 60/12; B25G 1/102; B29K 2077/00; B29L 2031/777; B33Y 70/00

(57) ABSTRACT

Methods for producing custom hand grips that are shaped to fit the hand of a specific user, and custom hand grips produced by the method. A sleeve of moldable material is applied to an internal frame in the shape of the desired handle, forming a moldable hand grip. The user grips the moldable material, deforming the moldable material to be shaped to conform to the hand of the user, forming a molded hand grip. The molded firearm hand grip is then scanned three dimensionally to produce an electronic file(s) containing information defining the exterior shape of the molded firearm grip. The electronic file is then used to produce a custom hand grip by machining and/or additive manufacturing processes. The invention includes methods and structures for all types of hand grips, including but not limited to firearm, sporting equipment and tool hand grips.

### CROSS REFERENCE TO RELATED APPLICATIONS AND INCORPORATION BY REFERENCE

This non-provisional application for patent claims benefit of priority to U.S. Provisional Patent Application No. 63/459,586, entitled CUSTOM, USER-SPECIFIC FIREARM GRIP AND METHOD OF MANUFACTURE, filed in the United States Patent and Trademark Office (USPTO) on Apr. 14, 2023, the disclosure of which is hereby incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### FIELD OF THE INVENTION

The field of the invention relates generally to systems and methods for producing custom-shaped hand grips for firearms, including but not limited to pistols, that are custom-shaped to fit the hand of a specific user. The field of the invention includes custom-shaped hand grip structures for all types of firearm grips, including but not limited to pistol hand grips, shotgun grips, rifle grips, crossbows, pellet guns, Air-Soft® guns and other firearm grips. The field of the invention also relates to generally to systems and methods for producing custom-shaped hand grips for any elongate or other structure having a hand grip, such as, for example and not by way of limitation, 1) custom-shaped hand grips for sporting equipment such as hand grips forming a part of or attached to tennis rackets, golf clubs, pickle ball paddles, ping pong paddles and all types of other sporting equipment; 2) custom-shaped hand grips for tools such as hand grips forming a part of or attached to wrenches, bars, and all types of other tools having a handle; and 3) any structure having or needing a handle for gripping by the hand of a person.

### BACKGROUND

It is well known in the art of firearm design that a user's ability to comfortably and reliably grip the firearm in a manner that is repeatable and fits ergonomically with the hand of the user. Ideally, firearm hand grips, such as pistol grips that are commonly used on pistols, rifles, shotguns, crossbows, pellet guns, Air Soft® guns and other firearms, would be closely matched ergonomically with the hand of the user. This close, custom ergonomic fit would enable easier use of the firearm over hand grips of the prior art, would allow more accurate aiming or pointing of the firearm over hand grips of the prior art, and would reduce user fatigue over hand grips of the prior art. However, a custom ergonomic fit between the firearm hand grip and a specific user's hand is difficult to achieve on a mass-produced scale due the vast differences in the sizes and shapes of firearm users' hands. The result is that the current firearm hand grip designs available in the art are “one-size-fits-all” designs. Even though such current firearm hand grips may be available in different sizes, they are not shaped to a specific user's hand in a truly custom fit that is tailored to match, and to be complementary with, the specific three-dimensional features forming that particular user's hand. Genetically, the specific three-dimensional features forming a particular user's hand are unique and particular to that particular user.

What is needed in the art, therefore, is an apparatus and/or method adapted to provide a firearm hand grip that is custom molded to the hand of a user, is producible on a large scale so that it can be made available to a large number of consumers, and is easily and quickly producible at a cost that is price competitive with the non-custom grips of the prior art.

### BRIEF SUMMARY OF THE INVENTION

The present invention overcomes the shortcomings of the prior art. The invention comprises an apparatus and method that have one or more of the following features and/or steps, which alone or in any combination may comprise patentable subject matter.

In embodiments, the invention comprises a method of manufacturing a hand grip that is shaped to confirm to, and to fit in complementary fashion with, a specific user's hand, comprising the steps of:
forming a custom hand grip using the steps of:
providing an inner frame 001 having a receiving portion 002 representing, i.e. shaped the same as, a desired receiving structure, wherein the desired receiving structure may be, for example, a pistol handle structure or other handle structure to which it is desired to attach a hand grip;
providing a sleeve of moldable material adapted to be motivated onto receiving portion 002 of inner frame 001 such that the sleeve of moldable material covers at least a portion of receiving portion 002;
motivating the sleeve of moldable material onto receiving portion 002 the inner frame 001, forming a moldable hand grip;
molding, i.e. forming, the outer surfaces of the moldable material of the moldable hand grip to conform to the hand of a specific user by the steps of:
   the user holding and gripping the moldable hand grip;
   the user applying a squeezing force with said hand to the moldable hand grip such that the user is holding the moldable hand grip with the same grip that the user would use to hold the desired receiving structure;
wherein said squeezing force displaces at least a portion of said moldable material forming the moldable hand grip, forming a molded hand grip with outer surfaces that are shaped to conform to and to fit the specific user's hand and to be complementary to the specific three-dimensional features of the user's hand when the user's hand is holding the desired receiving structure;
removing the user's hand from the molded hand grip;
scanning the outer surfaces of the molded hand grip to produce an electronic file containing information describing the three-dimensional shape of exterior surfaces of the molded hand grip;
producing a custom hand grip for attaching to the desired receiving structure by using manufacturing techniques, such as additive manufacturing techniques, to produce the custom hand grip, using information contained in the electronic file, such that the custom hand grip is adapted to mount to the desired receiving structure, wherein the outer surfaces of the custom hand grip are shaped and formed so as to conform to, and to be complementary with, the particular three-dimensional shape(s) of the features of the user's hand when the user is holding and gripping the custom hand grip; and
optionally, applying a texture, such as a fine grained texture, over at least apportion of the outer surfaces of the custom hand grip, which may be, for example and not meant to be limiting, a fine pyramid texture, random rough surfacing, a “leather” appearance texture, a cosmetic/decorative/ornamental or any other texture that provides raised or dimpled features on or in the outer surfaces of the custom hand grip that increase the friction between the skin of the hand of a user and the outer surface of the custom hand grip, increasing gripping ability of the user on the hand grip over a smooth finish on the outer surface of the custom hand grip.

In embodiments, the moldable material may be a thermo-moldable material, and wherein the step of molding may be preceded by the step of heating the moldable material to a temperature such that moldable material is able to displaced by the squeezing of the hand of the user when the user's hand and fingers are wrapped around and holding the moldable material.

In embodiments, the inner frame may comprise at least one or a plurality of openings 003 passing through the inner frame from an interior void, or volume, of the inner frame to an exterior surface of the inner frame in the receiving portion, such that the moldable material is able to be displaced through the one or more openings onto the interior volume of the inner frame when a user applies the squeezing force with said hand to said moldable material.

In embodiments, the desired receiving structure may be further defined as a pistol having a hand grip.

In embodiments, the desired receiving structure may be further defined as a rifle having a hand grip.

In embodiments, the desired receiving structure may be further defined as a shotgun having a hand grip.

In embodiments, the desired receiving structure may be a pellet gun having a hand grip.

In embodiments, the desired receiving structure may be a crossbow having a hand grip.

In embodiments, the custom firearm grip may further comprise a trigger guard portion.

In embodiments, the custom firearm grip of the invention may be adapted to mount to a handle portion of a frame of a firearm.

In embodiments, the desired receiving structure may be any item of sporting equipment having a hand grip.

In embodiments, the desired receiving structure may be any tool having a hand grip.

In embodiments, the desired receiving structure may be any structure, of any kind or nature, having a hand grip.

The invention further comprises a user-specific custom hand grip, comprising an outer surface(s) that is/are custom-shaped and formed to conform to a specific user's hand and grip style, wherein said outer surface(s) of the hand grip is/are produced by the steps of:
providing an inner frame 001, said inner frame 001 having a receiving portion 002 representing, i.e. shaped the same as, a desired receiving structure;
providing a sleeve of moldable material adapted to slide onto receiving portion 002 of the inner frame 001 such that the sleeve of moldable material covers at least a portion of receiving portion 002;
motivating the sleeve of moldable material onto portion 002 of the inner frame 001, forming a moldable hand grip;
molding, i.e. forming, the outer surfaces of the moldable material of the moldable hand grip to conform to the hand of a specific user by the steps of:
   the user holding and gripping the moldable hand grip;
   the user applying a squeezing force with said hand to the moldable hand grip such that the user is holding the moldable hand grip with the same grip that the user would use to hold the desired receiving structure;
wherein said squeezing force displaces at least a portion of the moldable material forming the moldable hand grip, forming a molded hand grip with outer surfaces that are shaped to conform to and to fit the specific user's hand and to be complementary to the specific three-dimensional features of the user's hand when the user's hand is holding the desired receiving structure;
removing the user's hand from the molded hand grip;
scanning the outer surfaces of the molded hand grip to produce an electronic file containing information describing the three-dimensional shape of exterior surfaces of the molded hand grip;
using manufacturing techniques, such as additive manufacturing techniques, to produce a custom hand grip, using the information contained in the electronic file, such that the custom hand grip is adapted to attach to the desired receiving structure, and has a custom hand grip outer surface(s) that is/are shaped to conform to the specific user's hand; and
optionally, applying a texture, such as a fine-grained texture, over at least a portion of the outer surfaces of the custom hand grip, which may be, for example and not meant to be limiting, a fine pyramid texture, random rough surfacing, a “leather” appearance texture, a cosmetic/decorative/ornamental or any other texture that provides raised or dimpled features on or in the outer surfaces of the custom hand grip that increase the friction between the skin of the hand of a user and the outer surface of the custom hand grip, increasing gripping ability of the user on the hand grip over a smooth finish on the outer surface of the custom hand grip.

The present method and device of the invention overcome the shortcomings of the prior art by utilizing moldable material that is able to molded to the hand of a user to produce a custom firearm grip that is shaped to the hand of the user. By the use of plastic materials and additive manufacturing techniques, or other production techniques, the custom hand grip of the invention is able to be produced in quantities such that the custom hand grip may be made available to consumers at a cost that is price competitive with non-custom hand grips of the prior art.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating exemplary embodiments of the invention and are not to be construed as limiting the invention. In the drawings:

FIG. 1 is a drawing of an exemplary internal frame 001 of the invention, that is adapted to receive the sleeve made of moldable material on a receiving portion 002 of the inner frame 001 that is shaped in the shape of the desired receiving structure. In embodiments, the inner frame 001 may comprise at least one or a plurality of openings 003 passing through the inner frame 001 from an interior void, or volume. of the inner frame to an exterior surface of the inner frame in the receiving portion region of the inner frame, such that the moldable material is able to be displaced (or “squeezed”) into and through the one or more openings 003 and into the interior volume of inner frame 001 when a user applies the squeezing force with said hand to said moldable material, enabling a true custom fit to the particular user's hand by allowing moldable material to be displaced into the inner frame as required to enable the outer surface(s) of the molded hand grip to conform to specific three-dimensional shape(s) of the features of the user's hand that are formed when the user grips and squeezes the moldable hand grip.

FIG. 2 is a drawing of an exemplary embodiment of a custom hand grip produced by the method of the invention, showing features shaped and conformed to the hand features of a specific user that are complementary to the particular three-dimensional features of the user's hand. This drawing depicts the custom hand grip immediately after it has been produced by additive manufacturing process, prior to additive manufacturing artifacts 011 being removed. The exemplary embodiment depicted in FIG. 2, the desired receiving structure is a handle of a pistol, but this specific application and use is not to be considered limiting.

FIG. 3 depicts a photograph of an exemplary embodiment of a custom firearm hand grip 005 produced by the method of the invention, showing features 007 shaped and customized to conform to the particular three-dimensional features and shape(s) of the hand of a specific user.

This photograph depicts the custom hand grip 005 immediately after it has been produced by additive manufacturing process, after the additive manufacturing artifacts 011 have been removed. In the non-limiting example shown in FIG. 3, the desired receiving structure is the handle of a firearm, such as a pistol, and the final custom hand grip is a pistol hand grip. However this specific application and use of the invention is not to be considered as limiting, as the method and custom hand grip of the invention may be adapted to be received by any handle structure.

FIG. 4 depicts a flow chart of the steps of the method of the invention.

### DETAILED DESCRIPTION OF THE INVENTION

The following documentation provides a detailed description of the invention.

Although a detailed description as provided in this application contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

As used herein, “firearm” includes within its meaning any device or apparatus that propels a projectile. Thus, “firearm” includes but is not limited to pistols, handguns of any type, long arms (e.g. rifles), shotguns and crossbows. Also included with the meaning of “firearm” are pellet guns, BB guns, Air Soft® guns, and all other forms and types of devices that project or propel a projectile of any type.

As used herein, “desired receiving structure” is any structure to which it is desired to attached a hand grip. Thus, firearms, tools and sporting equipment are all non-limiting embodiments of desired receiving structures.

As used herein, “additive manufacturing”, or 3D printing, includes within its meaning the construction of a three-dimensional object from a computer aided design (CAD) model or a digital 3D model, which may be, for example, an electronic file containing information describing the shape and features of the item to be produced, such as the custom firearm grip of the invention. Additive manufacturing can be accomplished in a variety of processes in which material is deposited, joined or solidified under computer control, with material being added together (such as plastics, liquids or powder grains being fused), typically layer by layer.

As used herein, “grip” and “hand grip” means a structure meant to gripped by a hand of a user for holding or grasping a desired receiving structure. Thus, for example, and not by way of limitation, “grip” and “hand grip” include within their meanings firearm hand grips, and even more specifically, and not by way of limitation “pistol grips”. The hand grips of the invention may be used on or with any receiving structure.

As used herein, “moldable material” includes within its meaning any material that is deformable by the grip, or hand pressure, of a user to form a molded firearm hand grip that conforms to the shape of the user's hand as described herein. Polycaprolactone (PCL) and similar materials are examples of a moldable material. Thus, “moldable materials” includes within its meaning polyester materials with a low melting point of around 60° C. and a glass transition temperature of about −60° C. In embodiments, polycaprolactone moldable materials may be heated by, for example, immersion in hot water or microwaving, in order to soften the material such that it requires less force to be molded into the shape of a user's hand as described herein.

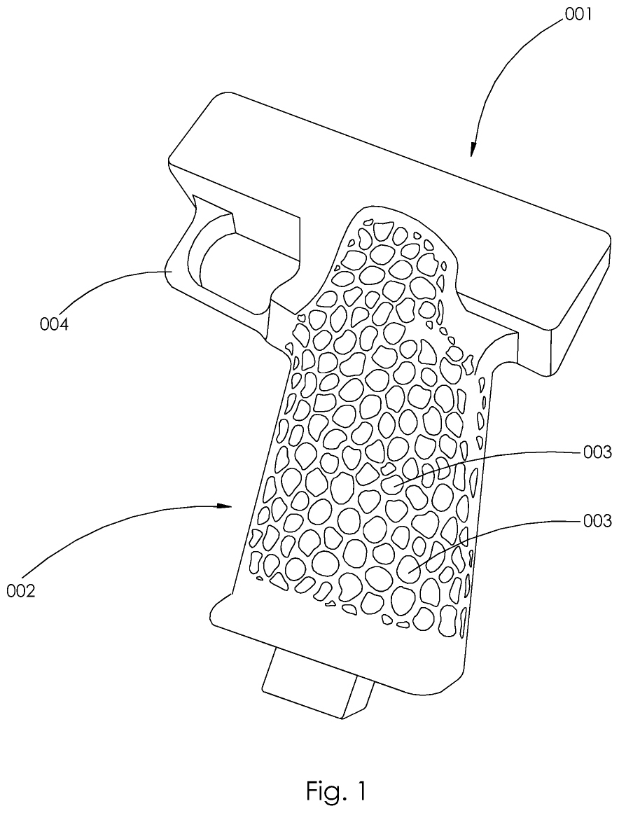

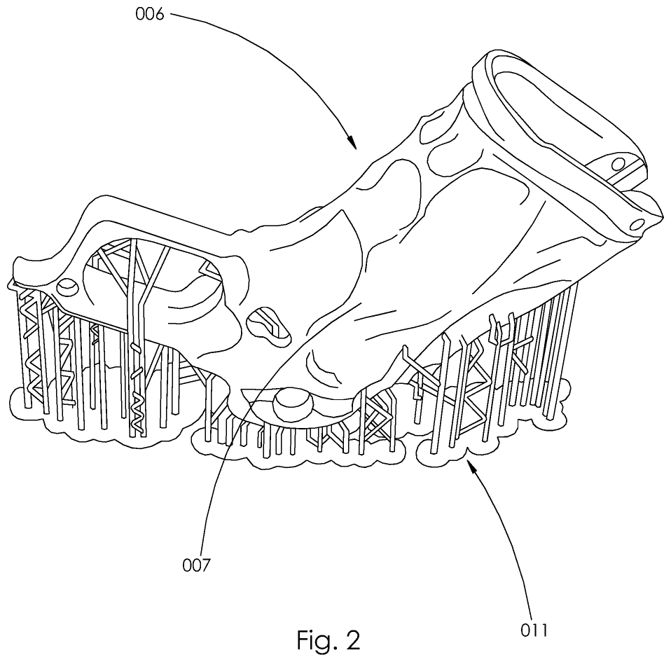

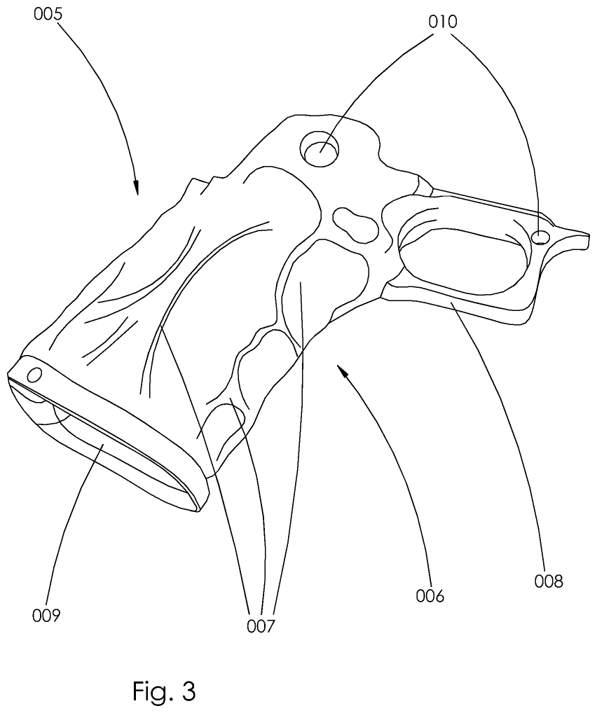

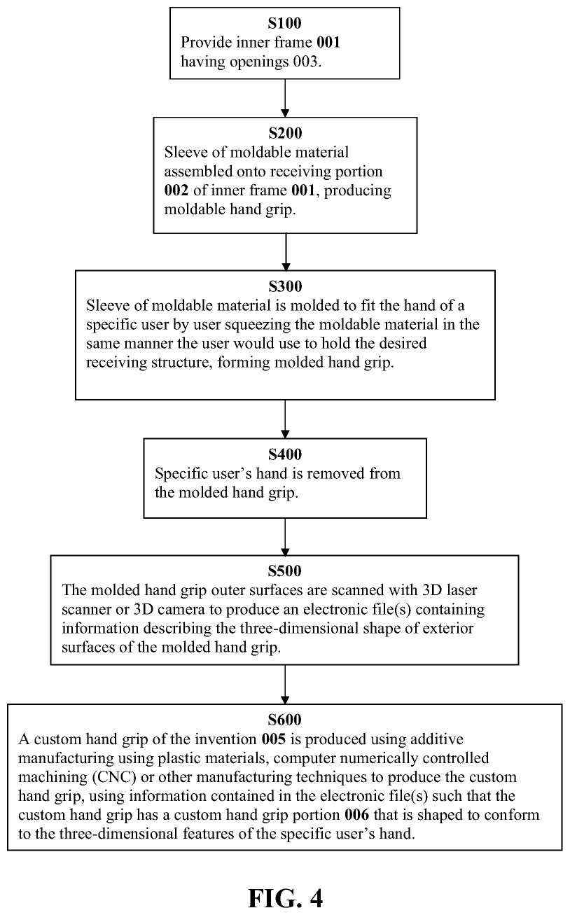

Referring now to FIGS. 1-4, the method and process of the invention includes the following steps.

In a first step S100 an inner frame 001 is provided, the inner frame having a receiving portion 002 that represents, i.e. is shaped the same as, a desired receiving structure that is intended to receive a custom hand grip of the invention. In the non-limiting example shown in FIGS. 1-3, the desired receiving structure is the handle of a pistol, and thus the inner frame 001 has a portion 002 that represents a pistol handle that is intended to receive a pistol hand grip. However, again, the application of a pistol hand grip is exemplary only, and not limiting.

In a second S200 step a sleeve of moldable material adapted to be motivated onto receiving portion 002 of the inner frame 001 is provided and is motivated, or assembled, onto receiving portion 002 of the inner frame 001 such that said sleeve of moldable material covers at least a portion of receiving portion 002 of said inner frame 001, forming a moldable firearm grip.

In a third step S300 the moldable material of the moldable firearm grip is molded to the hand of a specific user by the user holding, gripping and squeezing the moldable hand grip. The sleeve of moldable material forming the moldable hand grip may be heated prior to molding by any means known in the art, which may include immersion in hot water, by microwave heating, or other heating means. The user then applies a squeezing force to the moldable material with their gripping hand such that user is holding the moldable handgrip with the same grip that the user would use to hold desired receiving structure when the hand grip is assembled onto to desired receiving structure. The squeezing force displaces at least a portion of the moldable material, forming a custom molded firearm grip with outer surfaces that are shaped to fit and to be complementary with the specific three-dimensional features and shapes of the user's hand.

In a fourth step S400 the user's hand is removed from the molded hand grip.

In a fifth step S500 the molded hand grip outer surfaces are scanned using laser scanning, three dimensional cameras, or other three-dimensional scanning techniques to produce an electronic file, or plurality of files, containing information describing the three-dimensional shape of exterior surfaces of the molded hand grip.

In a sixth step S600, a custom hand grip 005 of the invention is produced using, for example, additive manufacturing using plastic materials (such as, for example, nylon or resin materials) or computer numerically controlled machining (CNC) techniques to produce the custom firearm hand grip, using information contained in the electronic file such that the custom firearm grip is adapted to mount to a firearm, and has a custom firearm grip portion that is shaped to confirm to the specific user's hand.

The custom hand grip of the invention 005 may comprise features for attaching to the frame of a receiving structure such as openings 010, and may further comprise features for receiving elements of the receiving structure such as opening 009. Exterior three-dimensional features and surfaces 007 of the hand grip portion 006 of the custom hand grip 005 are shaped to fit closely, in a custom, complementary, fitted manner, with the hand of the specific user when the user grips the custom hand grip 005 when it is installed on the desired receiving structure, which in the non-limiting example shown in FIGS. 1-3, is a pistol handle.

In embodiments intended for use as firearm grips, the custom hand grip of the invention 005 may comprise a trigger guard portion 004 or 008.

Optionally, a texture may be applied to the outer surfaces of the custom grip by applying a fine-grained texture over the finished grip, which may be, for example and not mean to be limiting, a fine pyramid texture, random rough surfacing, a “leather” appearance texture, or a cosmetic/decorative/ornamental design. This is done to increase the friction of the finished surface, as well as improving the aesthetics of the finished piece. This is something that is only possible because the hand impression is digitally transferred onto the finished grip design, and can then be further processed to add texture (or logos, monograms, etc.) prior to 3D printing. Other non-digital techniques such as carving, or simply casting a hand impression in situ around the actual grip, do not allow for further customization on top of the molded surface.

The scope of the invention and the appended claims includes the features and elements as described herein and depicted in the figures, and all functional and legal equivalents. The examples depicted in the figures are exemplary only, and are not intended to be limiting to the scope of the invention.

What is claimed is:

1. A method of manufacturing a custom hand grip that is shaped to confirm to a specific user's hand, comprising the steps of:
forming a molded firearm hand grip using the steps of:
providing an inner frame, said inner frame having a receiving portion representing a desired receiving structure;
providing a sleeve of moldable material adapted to be motivated onto said inner frame receiving portion such that said sleeve of moldable material covers at least a portion of said inner frame receiving portion, forming the moldable firearm hand grip;
molding the moldable material of the moldable hand grip to the hand of a specific user by the specific user holding the moldable hand grip that is at least partially covered by the moldable material, the user applying a squeezing force with said hand to said moldable material such that user is holding the moldable hand grip with the same grip that the user would use to hold the desired receiving structure;
wherein said squeezing forces displaces at least a portion of said moldable material on the moldable hand grip, forming a molded hand grip with outer surfaces that are shaped to conform to, and to be complementary with, the particular three-dimensional shape(s) of the features of the specific user's hand;
removing the user's hand from the molded hand grip;
scanning, three-dimensionally, the outer surfaces of the molded hand grip to produce an electronic file containing information describing the three-dimensional shape of exterior surfaces of the molded hand grip;
producing a custom hand grip for use with the desired receiving structure by using manufacturing techniques to produce the custom hand grip, using information contained in the electronic file, such that the custom hand grip is adapted to be attached to the desired receiving structure;
and wherein the custom hand grip is custom-shaped to conform to, and to be complementary with, the particular three-dimensional shape(s) of the features of the specific user's hand.

2. The method of claim 1, wherein the manufacturing techniques are further defined as including additive manufacturing techniques.

3. The method of claim 1, wherein the moldable material is a thermo-moldable material, and where the step of molding is preceded by the step of heating the moldable material to a temperature such that moldable material is able to displaced by the squeezing of the hand of the user.

4. The method of claim 1, wherein the inner frame comprises openings passing through the inner frame from an interior volume of the inner frame to an exterior surface of the receiving portion of the inner frame, such that the moldable material is able to be displaced through the one or more openings into the interior volume of the inner frame when a user applies the squeezing force with said hand to said moldable material.

5. The method of claim 2, wherein the inner frame comprises openings passing through the inner frame from an interior volume of the inner frame to an exterior surface of the receiving portion of the inner frame, such that the moldable material is able to be displaced through the one or more openings into the interior volume of the inner frame when a user applies the squeezing force with said hand to said moldable material.

6. The method of claim 3, wherein the inner frame comprises openings passing through the inner frame from an interior volume of the inner frame to an exterior surface of the receiving portion of the inner frame, such that the moldable material is able to be displaced through the one or more openings into the interior volume of the inner frame when a user applies the squeezing force with said hand to said moldable material.

7. The method of claim 1, wherein the desired receiving structure is further defined as a firearm handle.

8. The method of claim 7, wherein the firearm handle is further defined as being selected from the group consisting of a pistol handle, a rifle handle, a shotgun handle, a crossbow handle, and an air pellet gun handle.

9. The method of claim 7, wherein the custom hand grip further comprises a trigger guard portion.

10. The method of claim 1, wherein the desired receiving structure is further defined as being selected from the group consisting of a tool handle and a sports equipment handle.

11. A user-specific custom firearm hand grip, comprising:
an outer surface shaped to conform to conform to, and to be complementary with, the particular three-dimensional shape(s) of the features of the specific user's hand;
wherein said outer surface is produced by the steps of
providing an inner frame, said inner frame having a receiving portion representing a desired receiving structure;
providing a sleeve of moldable material adapted to be motivated onto said inner frame receiving portion such that said sleeve of moldable material covers at least a portion of said inner frame receiving portion, forming the moldable firearm hand grip;
molding the moldable material of the moldable hand grip to the hand of a specific user by the specific user holding the moldable hand grip that is at least partially covered by the moldable material, the user applying a squeezing force with said hand to said moldable material such that user is holding the moldable hand grip with the same grip that the user would use to hold the desired receiving structure;
wherein said squeezing forces displaces at least a portion of said moldable material on the moldable hand grip, forming a molded hand grip with outer surfaces that are shaped to conform to, and to be complementary with, the particular three-dimensional shape(s) of the features of the specific user's hand;
removing the user's hand from the molded hand grip;
scanning, three-dimensionally, the outer surfaces of the molded hand grip to produce an electronic file containing information describing the three-dimensional shape of exterior surfaces of the molded hand grip;
producing a custom hand grip for use with the desired receiving structure by using manufacturing techniques to produce the custom hand grip, using information contained in the electronic file, such that the custom hand grip is adapted to be attached to the desired receiving structure;
wherein the custom hand grip is custom-shaped to conform to, and to be complementary with, the particular three-dimensional shape(s) of the features of the specific user's hand.

12. The method of claim 11, wherein the manufacturing techniques are further defined as including additive manufacturing techniques.

13. The custom firearm grip of claim 11, wherein the moldable material is a thermo-moldable material, and where the step of molding is preceded by the step of heating the moldable material to a temperature such that moldable material is able to displaced by the squeezing of the hand of the user.

14. The method of claim 11, wherein the inner frame comprises openings passing through the inner frame from an interior volume of the inner frame to an exterior surface of the receiving portion of the inner frame, such that the moldable material is able to be displaced through the one or more openings into the interior volume of the inner frame when a user applies the squeezing force with said hand to said moldable material.

15. The method of claim 12, wherein the inner frame comprises openings passing through the inner frame from an interior volume of the inner frame to an exterior surface of the receiving portion of the inner frame, such that the moldable material is able to be displaced through the one or more openings into the interior volume of the inner frame when a user applies the squeezing force with said hand to said moldable material.

16. The method of claim 13, wherein the inner frame comprises openings passing through the inner frame from an interior volume of the inner frame to an exterior surface of the receiving portion of the inner frame, such that the moldable material is able to be displaced through the one or more openings into the interior volume of the inner frame when a user applies the squeezing force with said hand to said moldable material.

17. The method of claim 11, wherein the desired receiving structure is further defined as a firearm handle.

18. The method of claim 17, wherein the firearm handle is further defined as being selected from the group consisting of a pistol handle, a rifle handle, a shotgun handle, a crossbow handle, and an air pellet gun handle.

19. The method of claim 17, wherein the custom hand grip further comprises a trigger guard portion.

20. The method of claim 11, wherein the desired receiving structure is further defined as being selected from the group consisting of a tool handle and a sports equipment handle.
